(19) United States
(12) Patent Application Publication
(10) Pub. No.: US 2004/0242782 A1
(43) Pub. Date: Dec. 2, 2004

(54) Rubber composition and vulcanized rubber

(75) Inventors: Sadayuki Nakano, Ichihara-shi (JP); Tatsuo Sassa, Ichihara-shi (JP); Jun Kawashima, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/852,154

(22) Filed: May 25, 2004

(30) Foreign Application Priority Data
May 29, 2003 (JP) 2003-152083
May 29, 2003 (JP) 2003-152084

(51) Int. Cl. C08F 8/00; C08L 45/00

(52) U.S. Cl. 525/191; 525/192

(57) ABSTRACT

A rubber composition comprising the following components (A), (B1) or (B2), and (C):

(A) an ethylene-α-olefin copolymer rubber and/or an ethylene-α-olefin-non-conjugated diene copolymer rubber,

(B1) an organic compound having a weight average molecular weight of from 1,000 to 1,000,000, and containing a silicon atom in an amount of from 2 to 30% by weight, wherein the total amount of the organic compound is 100% by weight, or (B2) an ethylene-α-olefin-silylnorbornene copolymer rubber, and

(C) a reinforcement; and vulcanized rubber produced by a process comprising the step of vulcanizing said rubber composition.

### FIELD OF THE INVENTION

The present invention relates to a rubber composition, and vulcanized rubber produced by vulcanizing said rubber composition.

### BACKGROUND OF THE INVENTION

Low-unsaturated rubber such as ethylene-α-olefin-non-conjugated diene copolymer rubber is excellent in its heat resistance, but is not excellent in its durability, wherein the term “low-unsaturated rubber” means rubber containing a small amount of an unsaturated carbon-carbon bond. In order to improve said durability, there are known:

(1) a method of using ethylene- α-olefin-non-conjugated diene copolymer rubber having a higher molecular weight,

(2) a method of using ethylene- α-olefin-non-conjugated diene copolymer rubber containing a large amount of an ethylene unit, and

(3) a method of blending carbon black having a high structure with said copolymer rubber, wherein the term “carbon black having a high structure” means carbon black, particles of which are connected to each other to make long chains.

### SUMMARY OF THE INVENTION

However, the above-mentioned method (1) cannot improve durability sufficiently, the above-mentioned method (2) deteriorates a low temperature resistance remarkably, and the above-mentioned method (3) has a bad kneadability of the carbon black with the copolymer rubber.

An object of the present invention is to provide a rubber composition, and vulcanized rubber produced by vulcanizing said rubber composition, both of which have excellent durability.

The present invention is a rubber composition comprising the following components (A), (B1) and (C):

(A) an ethylene-α-olefin copolymer rubber and/or an ethylene-α-olefin-non-conjugated diene copolymer rubber,

(B1) an organic compound having a weight average molecular weight of from 1,000 to 1,000,000, and containing a silicon atom in an amount of from 2 to 30% by weight, wherein the total amount of the organic compound is 100% by weight, and

(C) a reinforcement.

The present invention is also a vulcanized rubber produced by a process comprising the step of vulcanizing said rubber composition.

The present invention is further a rubber composition comprising the following components (A), (B2) and (C):

(A) an ethylene-α-olefin copolymer rubber and/or an ethylene-α-olefin-non-conjugated diene copolymer rubber,

(B2) an ethylene-α-olefin-silylnorbornene copolymer rubber, and

(C) a reinforcement.

The present invention is still further a vulcanized rubber produced by a process comprising the step of vulcanizing said rubber composition.

In the present invention, the term “vulcanized” means “crosslinked” or “cured”; namely, these terms have the same meaning.

### DETAILED DESCRIPTION OF THE INVENTION

An α-olefin in both of the ethylene-α-olefin copolymer rubber (hereinafter, referred to as “copolymer rubber 1”) and the ethylene-α-olefin-non-conjugated diene copolymer rubber (hereinafter, referred to as “copolymer rubber 2”) of the component (A) means an α-olefin containing from 3 to 10 carbon atoms. Hereinafter, the copolymer rubber 1 and the copolymer rubber 2 are collectively referred to “copolymer rubber”. Examples of the α-olefin are propylene, 1-butene, 1-pentene, 1-hexene, 4-methyl-1-pentene, 1-octene and 1-decene. Among them, preferred is propylene or 1-butene.

A ratio by weight of an ethylene unit to an α-olefin unit contained in the copolymer rubber is preferably from 80/20 to 40/60, and further preferably from 65/35 to 45/55. In the present invention, the term such as the “ethylene unit” means a polymerized monomer unit such as a polymerized ethylene unit. When said ratio is larger than 80/20, the obtained rubber composition has a remarkably bad low temperature resistance, and as a result, its rubber properties shown at ordinary temperature may not be shown in winter or in a cold area. When said ratio is smaller than 40/60, the obtained rubber composition may be inferior in its durability.

Mooney viscosity (ML₁₊₄, 121° C.) of the copolymer rubber is preferably from 50 to 200, and further preferably from 55 to 200. When said Mooney viscosity is lower than 50, the obtained rubber composition may be very inferior in its durability. When said Mooney viscosity is higher than 200, the obtained rubber composition may not be further improved in its durability, and therefore, it may not be suitable from an economical point of view.

The term “non-conjugated diene” in the copolymer rubber 2 means not only a non-conjugated diene compound containing from 2 to 16 carbon atoms, but also a non-conjugated polyene compound containing from 2 to 16 carbon atoms such as a non-conjugated triene compound. Examples of the compound are a linear non-conjugated diene such as 1,4-hexadiene, 1,6-octadiene, 2-methyl-1, 5-hexadiene, 6-methyl-1,5-heptadiene and 7-methyl-1,6-octadiene; a cyclic non-conjugated diene such as cyclohexadiene, dicyclopentadiene, methyltetraindene, 5-vinylnorbornene, 5-ethylidene-2-norbornene and 6-chloromethyl-5-isopropenyl-2-norborne; and a triene such as 2,3-diisopropylidene-5-norbornene, 2-ethylidene-3-isopropylidene-5-norbornene, 2-propenyl-2,2-norbornadiene, 1,3,7-octatriene and 1,4,9-decatriene. Further examples of the compound are 5-vinyl-2-norbornene, 5-(2-propenyl)-2-norbornene, 5-(3-butenyl)-2-norbornene, 5-(4-pentenyl)-2-norbornene, 5-(5-hexenyl)-2-norbornene, 5-(5-heptenyl)-2-norbornene, 5-(7-octenyl)-2-norbornene, 5-methylene-2-norbornene, 6,10-dimethyl-1,5,9-undecatriene, 5,9-dimethyl-1,4,8-decatriene, 4-ethylidene-8-methyl-1,7-nonadiene, 13-ethyl-9-methyl-1,9,12-pentadecatriene, 5,9,13-trimethyl-1,4,8,12-tetradecadiene, 8,14,16-trimethyl-1,7,14-hexadecatriene and 4-ethylidene-12-methyl-1,11-pentadecadiene. These compounds may be used singly, respectively, or in combination of two or more thereof. Among them, preferred is 5-ethylidene-2-norbornene, dicyclopentadiene or a combination thereof.

An amount of a non-conjugated diene unit contained in the copolymer rubber 2 is preferably from 8 to 36, and further preferably from 10 to 30 in terms of an iodine value of the copolymer rubber 2. When said amount is less than 8, the obtained rubber composition may be inferior in its durability because of insufficient crosslinking density. When said amount is more than 36, the obtained rubber composition may below in its tensile strength.

An example of the copolymer rubber 1 is ethylene-propylene copolymer rubber, and an example of the copolymer rubber 2 is ethylene-propylene-5-ethylidene-2-norbornene copolymer rubber.

The copolymer rubber 1 may be used singly, or in combination of two or more thereof. Similarly, the copolymer rubber 2 may be used singly, or in combination of two or more thereof. When combining two or more thereof, the above-mentioned “ratio by weight of an ethylene unit to an α-olefin unit”, “Mooney viscosity” and “iodine value” mean those of said combined copolymer rubber. The copolymer rubber may be used in combination with extender oil.

A process for producing the above-mentioned copolymer rubber is not limited, and may be a process known in the art. Examples of a polymerization catalyst for producing said copolymer rubber are a titanium-based catalyst, a vanadium-based catalyst and a metallocene-based catalyst.

The component (B1) has a weight average molecular weight of from 1,000 to 1,000,000, and preferably from 100,000 to 800,000. When said weight average molecular weight is lower than 1,000, the obtained rubber composition is inferior in its durability. When said weight average molecular weight is higher than 1,000,000, the obtained rubber composition may not be further improved in its durability, and therefore, it may not be suitable from an economical point of view. The component (B1) contains a silicon atom in an amount of from 2 to 30% by weight, and preferably from 3 to 28% by weight, wherein the total amount of the component (B1) is 100% by weight. When said amount is less than 2% by weight, the obtained rubber composition is inferior in its durability. When said amount is more than 30% by weight, the obtained rubber composition is not further improved in its durability, and therefore, it is not suitable from an economical point of view.

The component (B1) is contained in the rubber composition in accordance with the present invention in an amount of preferably from 0.1 to 50 parts by weight, and further preferably from 0.2 to 30 parts by weight, per 100 parts by weight of the component (A). When said amount is less than 0.1 part by weight, the obtained rubber composition may be inferior in its durability. When said amount is more than 50 parts by weight, the obtained rubber composition may not be further improved in its durability, and therefore, it may not be suitable from an economical point of view.

An example of the component (B1) is a silicone·polyolefin graft compound having a trade name of SILGRAFT-250, manufactured by Nippon Unicar Co., Ltd.

An α-olefin in the component (B2) has the same meaning as that in the above-mentioned copolymer rubber, and examples thereof are those mentioned above. Among them, preferred is propylene or 1-butene.

A ratio by weight of an ethylene unit to an α-olefin unit contained in the component (B2) is preferably from 80/20 to 40/60, and further preferably from 65/35 to 45/55 for the same reason as the above-mentioned reason for the above-mentioned copolymer rubber.

Mooney viscosity (ML₁₊₄, 100° C.) of the component (B2) is preferably from 20 to 200, and further preferably from 50 to 190. When said Mooney viscosity is lower than 20, the obtained rubber composition may be very inferior in its durability. When said Mooney viscosity is higher than 200, the obtained rubber composition may not be further improved in its durability, and therefore, it may not be suitable from an economical point of view.

Examples of the silylnorbornene in the component (B2) are triethoxysilylnorbornene, trichlorosilylnorbornene, dichloromethylsilylnorbornene and trimethylsilylnorbornene. These compounds may be used singly, respectively, or in combination of two or more thereof.

An example of the component (B2) is ethylene-propylene-trichlorosilylnorbornene copolymer rubber.

The component (B2) may be used singly, or in combination of two or more thereof. When combining two or more thereof, the above-mentioned “ratio by weight of an ethylene unit to an α-olefin unit” and “Mooney viscosity” mean those of said combined copolymer rubber. The component (B2) may be used in combination with extender oil.

The component (B2) contains a silicon atom in an amount of preferably from 0.1 to 30% by weight, wherein the total amount of the component (B2) is 100% by weight.

An example of a process for producing the component (B2) is a process comprising the step of copolymerizing ethylene, an α-olefin having from 3 to 20 carbon atoms and a silylnorbornene using a transition metal complex and an organoaluminum compound.

An example of the above-mentioned silylnorbornene is a compound represented by the following formula:

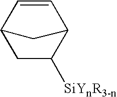

wherein each Y (in case of n is 2 or 3) is independently of each other a halogen atom, an alkoxy group, a hydroxyl group or a siloxy group; R is an alkyl group; and n is an integer satisfying 1≦n≦3.

Examples of the above-mentioned halogen atom of Y are a chlorine atom, a bromine atom and an iodine atom; examples of the above-mentioned alkoxy group thereof are a methoxy group, an ethoxy group, a n-propoxy group, an isopropoxy group, a n-butoxy group, a sec-butoxy group and a tert-butoxy group; and examples of the siloxy group thereof are a trimethylsiloxy group, a triethylsiloxy group, a tri-n-propylsiloxy group, a triisopropylsiloxy group, a tri-n-butylsiloxy group, a tri-sec-butylsiloxy group, a tri-tert-butylsiloxy group, a triphenylsiloxy group, a trimethoxysiloxy group, a triethoxysiloxy group, a tri-n-propoxysiloxy group, a triisopropoxysiloxy group, a tri-n-butoxysiloxy group, a tri-sec-butoxysiloxy group, a tri-tert-butoxysiloxy group and a triphenoxysiloxy group.

Examples of the above-mentioned alkyl group of R are a methyl group, an ethyl group, a n-propyl group, an isopropyl group, a n-butyl group, a sec-butyl group, and a tert-butyl group.

Examples of the compound represented by the above-mentioned formula are 5-trichlorosilyl-2-norbornene, 5-dichloromethylsilyl-2-norbornene, 5-chlorodimethylsilyl-2-norbornene, 5-tribromosilyl-2-norbornene, 5-dibromomethylsilyl-2-norbornene, 5-bromodimethylsilyl-2-norbornene, 5-dichloroethylsilyl-2-norbornene, 5-chlorodiethylsilyl-2-norbornene, 5-trimethoxysilyl-2-norbornene and 5-triethoxysilyl-2-norbornene. Among them, preferred is a compound whose silicon atom has a halogen atom-containing substituent group, and particularly preferred is a compound whose silicon atom has a chlorine atom-containing substituent group. An example of said compound is 5-trichlorosilyl-2-norbornene.

When using a halogenated silylnorbornene as the above-mentioned silylnorbornene, a halogenated silyl group contained in a produced copolymer rubber can easily be changed to a higher polarity-carrying alkoxysilyl group by recovering said produced copolymer rubber with a precipitation method using an alcohol.

The above-mentioned α-olefin having from 3 to 20 carbon atoms may be a combination of two or more thereof. Examples of the α-olefin are a linear olefin such as propylene, 1-butene, 1-pentene, 1-hexene, 1-heptene, 1-octene, 1-nonene and 1-decene; a branched olefin such as 3-methyl-1-butene, 3-methyl-1-pentene and 4-methyl-1-pentene; and vinylcyclohexane. Among them, propylene or 1-butene is preferable, and propylene is particularly preferable.

Examples of the above-mentioned polyene compound are a linear non-conjugated polyene compound, a linear conjugated polyene compound, a cyclic non-conjugated polyene compound and a cyclic conjugated polyene compound. Specific examples of the polyene compound are 1,4-hexadiene, 1,5-hexadiene, 1,5-heptadiene, 1,6-heptadiene, 1,6-octadiene, 1,7-octadiene, 1,7-nanodiene, 1,8-nanodiene, 1,8-decadiene, 1,9-decadiene, 1,12-tetradecadiene, 1,13-tetradecadiene, 3-methyl-1,4-hexadiene, 3-methyl-1,5-hexadiene, 3-ethyl-1,4-hexadiene, 3-ethyl-1,5-hexadiene, 3,3-dimethyl-1,4-hexadiene, 3,3-dimethyl-1,5-hexadiene, 5-ethylidene-2-norbornene, 5-propylidene-2-norbornene, 5-vinyl-2-norbornene, 2,5-norbornadiene, 7-methyl-2,5-norbornadiene, 7-ethyl-2,5-norbornadiene, 7-propyl-2,5-norbornadiene, 7-butyl-2,5-norbornadiene, 7-pentyl-2,5-norbornadiene, 7-hexyl-2,5-norbornadiene, 7,7-dimethyl-2,5-norbornadiene, 7,7-methylethyl-2,5-norbornadiene, 7-chloro-2,5-norbornadiene, 7-bromo-2,5-norbornadiene, 7-fluoro-2,5-norbornadiene, 7,7-dichloro-2,5-norbornadiene, 1-methyl-2,5-norbornadiene, 1-ethyl-2,5-norbornadiene, 1-propyl-2,5-norbornadiene, 1-butyl-2,5-norbornadiene, 1-chloro-2,5-norbornadiene, 1-bromo-2,5-norbornadiene, 1,3-butadiene, isoprene, 1,3-pentadiene, 2,3-dimethyl-1,3-butadiene and 1,3-hexadiene.

Further examples of the polyene compound are cyclic diene compounds having the following respective structures.

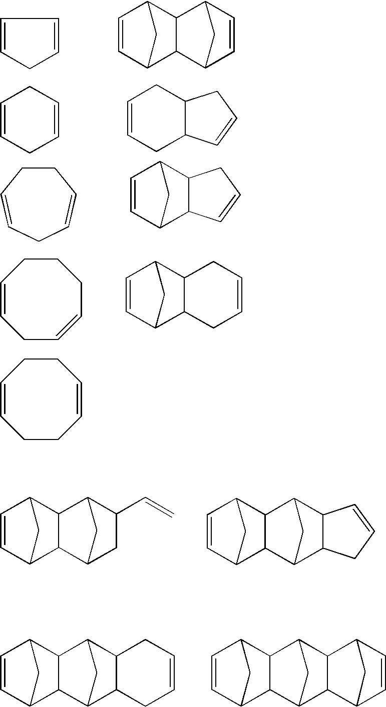

The polyene compound may be a combination of two or more of the above-mentioned polyene compounds. Among the above-mentioned polyene compounds, preferred is 5-ethylidene-2-norbornene, dicyclopentadiene or 1,4-hexadiene, from a viewpoint of availability, each of which is often used for producing EPDM.

An example of the above-mentioned transition metal complex used for producing the component (B2) is a vanadium compound represented by the following formula:

VO(OR′)ₐCl₃₋ₐ

wherein R′ is a hydrocarbon group; and a is a number satisfying 0≦a≦3.

The above-mentioned hydrocarbon group of R′ is preferably an alkyl group having from 1 to 20 carbon atoms. Examples of the alkyl group are an ethyl group, a n-propyl group, an isopropyl group, a n-butyl group, a sec-butyl group and a tert-butyl group.

Examples of the above-mentioned vanadium compound are vanadium oxytrichloride (VOCl₃), vanadium oxytriethoxide (VO(OEt)3), vanadium oxytriisopropoxide (VO(Oⁱ-Pr)₃), vanadium oxytri-n-propoxide (VO(Oⁿ-Pr)₃), vanadium oxytri-n-butoxide (VO(Oⁿ-Bu)₃), vanadium oxytri-sec-butoxide (VO(O^{s}-Bu)₃) and vanadium oxytri-tert-butoxide (VO(O^{t}-Bu)₃). Among them, preferred is vanadium oxytrichloride (VOCl₃).

An example of the above-mentioned organoaluminum compound used for producing the component (B2) is an organoaluminum compound represented by the following formula:

E_{a′}AlZ_{3-a′}

wherein E is a hydrocarbon group; Z is hydrogen or a halogen atom; and a′ is a number satisfying 0<a′≦3.

The above-mentioned hydrocarbon group of E is preferably a hydrocarbon group having from 1 to 8 carbon atoms, and more preferably an alkyl group.

Examples of the organoaluminum compound represented by the above-mentioned formula are a trialkylaluminum such as trimethylaluminum, triethylaluminum, tripropylaluminum, triisobutylaluminum and trihexylaluminum; a dialkylaluminum chloride such as dimethylaluminum chloride, diethylaluminum chloride, dipropylaluminum chloride, diisobutylaluminum chloride and dihexyaluminum chloride; an alkylaluminum dichloride such as methylaluminum dichloride, ethylaluminum dichloride, propylaluminum dichloride, isobutylaluminum dichloride and hexylaluminum dichloride; an alkylaluminum sesquichloride such as ethyl aluminum sesquichloride; and a dialkylaluminum hydride such as dimethylaluminum hydride, diethylaluminum hydride, dipropylaluminum hydride, diisobutylaluminum hydride and dihexylaluminum hydride. Among them, a chlorine atom-containing aluminum compound is preferable, and ethyl aluminum sesquichloride is more preferable.

The above-mentioned transition metal complex and organoaluminum compound are used in a molar ratio, organoaluminum compound/transition metal complex, of generally from 2 to 50, and preferably from 5 to 20.

When using the transition metal complex and/or the organoaluminum compound as a solution thereof dissolved in the below-mentioned polymerization solvent, or as a suspension thereof suspended therein, concentration of the solution or the suspension may be determined depending upon conditions such as performance of a feeder thereof to a polymerization reactor. The concentration of the transition metal complex is generally from 0.01 to 2.0 μmol/g-solution or g-suspension, and the concentration of the organoaluminum compound is generally from 0.1 to 8 μmol/g-solution or g-suspension.

An example of a copolymerization method for producing the component (B2) is a solvent polymerization method. Examples of the solvent in said polymerization method are an aliphatic hydrocarbon such as butane, pentane, hexane, heptane and octane; an aromatic hydrocarbon such as benzene and toluene; or a halogenated hydrocarbon such as methylene dichloride.

Polymerization temperature in the above-mentioned copolymerization is generally from −50 to 250° C., and particularly preferably from 20 to 70° C. Polymerization pressure therein is not particularly limited, and preferably from atmospheric pressure to 10 MPa. Polymerization time therein is generally determined depending upon the kind of a catalyst or a polymerization reactor used, and is generally from 1 minute to 20 hours. A chain transfer agent such as hydrogen may be used in order to control a molecular weight of the produced copolymer rubber.

A preferable example of a polymerization method for producing the component (B2) is a solvent polymerization method using an aliphatic hydrocarbon such as hexane, heptane and octane as the solvent.

The component (B2) is contained in the rubber composition in accordance with the present invention in an amount of preferably from 0.1 to 50 parts by weight, and further preferably from 0.2 to 30 parts by weight per 100 parts by weight of the copolymer rubber (A). When said amount is less than 0.1 part by weight, the obtained rubber composition may be inferior in its durability. When said amount is more than 50 parts by weight, the obtained rubber composition may not be further improved in its durability, and therefore, it may not be suitable from an economical point of view.

The component (C) means an ingredient used “in order to improve physical properties of the obtained rubber composition and the produced vulcanized rubber” such as tensile strength, impact resilience, abrasion resistance and durability. Examples thereof are carbon black generally used in combination with rubber such as SRF, GPF, FEF, HAF, ISAF, SAF, FT and MT; and an inorganic reinforcement such as finely powdery silicic acid, magnesium silicate, aluminum silicate and aluminum hydroxide.

The component (C) is contained in the rubber composition in accordance with the present invention in an amount of preferably from 5 to 200 parts by weight, and further preferably from 10 to 150 parts by weight per 100 parts by weight of the copolymer rubber (A). When said amount is less than 5 parts by weight, the obtained rubber composition may be inferior in its kneadability and tensile strength. When said amount is more than 200 parts by weight, the obtained rubber composition may be inferior in its kneadability.

If necessary, each of the components (A), (B) ((B1) and (B2)) and (C) may be combined with other components such as plasticizers, curing accelerators, curing agents, curing coagents, fillers (preferably, calcium carbonate), resins (for example, a polyethylene resin and a polypropylene resin) and other rubbers.

Examples of the above-mentioned plasticizer are those generally used in combination with rubber such as process oil, paraffin, liquid paraffin, petroleum asphalt, vaseline (petrolatum), coal tar pitch, castor oil, linseed oil, factice, beeswax, ricinolic acid, palmitic acid, barium stearate, calcium stearate, zinc laurate, atactic polypropylene and cumarone-indene resins. Among them, process oil is particularly preferable. The plasticizer is generally used in an amount of preferably from 20 to 150 parts by weight, and further preferably from 30 to 100 parts by weight per 100 parts by weight of the component (A) in order to obtain a rubber composition having a predetermined flexibility.

Examples of the above-mentioned curing accelerator are tetramethylthiuram monosulfide, teramethylthiuram disulfide, teraethylthiuram disulfide, terabutylthiuram disulfide, dipentamethylenethiuram monosulfide, dipentamethylenethiuram disulfide, dipentamethylenethiuram tetrasulfide, N,N′-dimethyl-N,N′-diphenylthiuram disulfide, N,N′-dioctadecyl-N,N′-diisopropylthiuram disulfide, N-cyclohexyl-2-benzothiazole-sufenamide, N-oxydiethylene-2-benzothiazole-sulfenamide, N,N-diisopropyl-2-benzothiazole-sulfenamide, 2-mercaptobenzothiazole, 2-(2,4-dinitrophenyl)mercaptobenzothiazole, 2-(2,6-diethyl-4-morpholinothio)benzothiazole, dibenzothiazyl-disulfide, diphenylguanidine, triphenylguanidine, di-o-tolylguanidine, o-tolyl-bi-guanide, diphenylguanidine-phthalate, an acetaldehyde-aniline reaction product, a butylaldehyde-aniline condensate, hexamethylenetetramine, acetaldehyde ammonia, 2-mercaptoimidazoline, thiocarbaniride, diethylthiourea, dibutylthiourea, trimethylthiourea, di-o-tolylthiourea, zinc dimethyldithiocarbamate, zinc diethylthiocarbamate, zinc di-n-butylthiocarbamate, zinc ethylphenyldithiocarbamate, zinc butylphenyldithiocarbamate, sodium dimethyldithiocarbamate, selenium dimethyldithiocarbamate, tellurium diethyldithiocarbamate, zinc dibutylxanthate and ethylenethiourea. The curing accelerator is generally used in an amount of preferably from 0.05 to 20 parts by weight, and further preferably from 0.1 to 8 parts by weight per 100 parts by weight of the component (A).

Examples of the above-mentioned curing agent are sulfur and an organic peroxide. Sulfur is used in an amount of preferably from 0.05 to 5 parts by weight, and further preferably from 0.1 to 3 parts by weight per 100 parts by weight of the component (A). Examples of the organic peroxide are dicumyl peroxide, 2,5-dimethyl-2,5-di(t-butylperoxy)hexane, 2,5-dimethyl-2,5-di(benzoylperoxy)hexane, 2,5-dimethyl-2,5-(t-butylperoxy)hexyne-3, di-t-butylperoxide, di-t-butylperoxide-3,3,5-trimethylcyclohexane and t-butylhydroperoxide. Among them, preferred is dicumyl peroxide, di-t-butylperoxide or t-butylperoxide-3,3,5-trimethylcyclohexane.

The organic peroxide is used in an amount of preferably from 0.1 to 15 parts by weight, and further preferably from 0.5 to 8 parts by weight per 100 parts by weight of the component (A).

If necessary, the organic peroxide may be combined with a coagent. Examples of the coagent are triallyl isocyanurate, N,N′-m-phenylenebismaleimide, methacrylic acid, methyl methacrylate, ethyl methacrylate, propyl methacrylate, isopropyl methacrylate, n-butyl methacrylate, isobutyl methacrylate, sec-butyl methacrylate, t-butyl methacrylate, 2-ethylhexyl methacrylate, cyclohexyl methacrylate, isodecyl methacrylate, lauryl methacrylate, tridecyl methacrylate, stearyl methacrylate, 2-hydroxyethyl methacrylate, hydroxypropyl methacrylate, polyethylene glycol monomethacrylate, polypropylene glycol monomethacrylate, 2-ethoxyethyl methacrylate, tetrahydrofurfuryl methacrylate, ally methacrylate, glycidyl methacrylate, benzyl methacrylate, dimethylaminoethyl methacrylate, diethylaminoethyl methacrylate, methacryloxyethyl phosphate, 1,4-butanediol diacrylate, ethylene glycol dimethacrylate, 1,3-butylene glycol dimethacrylate, neopentyl glycol dimethacrylate, 1,6-hexanediol dimethacrylate, diethylene glycol dimethacrylate, triethylene glycol dimethacrylate, polyethylene glycol dimethacrylate, dipropylene glycol dimethacrylate, polypropylene glycol dimethacrylate, trimethylolethane trimethacrylate, trimethylolpropane trimethacrylate, ally glycidyl ether, N-methylolmethacrylamide, 2,2-bis(4-methacryloxypolyethoxyphenyl) propane, aluminum methacrylate, zinc methacrylate, calcium methacrylate, magnesium methacrylate, and 3-chloro-2-hydroxypropyl methacrylate. The coagent is generally used in an amount of preferably from 0.05 to 15 parts by weight, and further preferably from 0.1 to 8 parts by weight per 100 parts by weight of the component (A).

Examples of the above-mentioned curing coagent are metal oxides such as magnesium oxide and zinc oxide. Among them, preferred is zinc oxide. The curing coagent is generally used in an amount of preferably from 1 to 20 parts by weight, and further preferably from 2 to 10 parts by weight per 100 parts by weight of the component (A).

The rubber composition of the present invention can be produced by mixing the components (A), (B) ((B1) or (B2)), (C) and optionally other component(s) in a conventional kneader such as a roll, a Banbury mixer and a kneader.

The vulcanized rubber of the present invention can be produced by a process comprising the step of vulcanizing the vulcanizable rubber composition of the present invention at generally 120° C. or higher, and preferably from 140 to 220° C. for from about 1 to about 60 minutes with an apparatus such as a hot air vulcanizing oven, a steam vulcanizing oven, a hot press, an injection molding machine and a compression molding machine.

Since the vulcanized rubber of the present invention is excellent in its durability, it is very suitable for uses such as a hose, a packing material, a weather strip, a rubber vibration insulator and a protector.

### EXAMPLE

The present invention is explained with reference to Examples, which are not intended to limit the scope of the present invention.

### 1. Components Used

(1) Component (A)

Oil-extended ethylene-propylene-5-ethylidene-2-norbornene copolymer rubber having Mooney viscosity (ML₁₊₄, 121° C.) of 60 and an iodine value of 10, and comprising (i) 100 parts by weight of ethylene-propylene-5-ethylidene-2-norbornene copolymer rubber having an ethylene unit content of 70% by weight and a propylene unit content of 30% by weight, the total of the both units being 100% by weight, and (ii) 40 parts by weight of extender oil.

(2) Component (B)

\mathring{1} Component (B1)

A silicone·polyolefin graft compound of a trade name of SILGRAFT-250 manufactured by Nippon Unicar Co., Ltd., having the following characteristics:

(i) it contains a continuous phase of an ethylene-vinyl acetate copolymer (EVA),

(ii) it contains 50% by weight of silicone, wherein the total weight of said graft compound is 100% by weight,

(iii) it has a melt index (MI) of 0.25 g/10 minutes,

(iv) it has a melting point of 73° C.,

(v) it has a weight average molecular weight of about 400,000, and

(vi) it contains 19% by weight of a silicon atom, wherein the total amount of said graft compound is 100% by weight.

\mathring{2} Component (B2)

Ethylene-propylene-trichlorosilylnorbornene copolymer rubber produced in the below-mentioned Reference Example 1, and having the following characteristics, wherein the total amount of said copolymer rubber is 100% by weight:

(i) a content of a propylene unit is 46% by weight,

(ii) a content of a trichlorosilylnorbornene unit is 6% by weight, and therefore, a content of a silicon atom is 0.79% by weight,

(iii) accordingly, a content of an ethylene unit is 48% by weight (=100%-46%-6%), and

(iv) a Q value is 11.7, wherein each of the content of a propylene unit and the content of a trichlorosilylnorbornene unit was measured by a method comprising the steps of:

(i) putting about 10 mg of said copolymer rubber into a sample tube having a diameter of 5 mm,

(ii) dissolving said copolymer rubber in 0.5 ml of orthodichlorobenzene-d₄,

(iii) measuring a proton nuclear magnetic resonance spectrum (¹H-NMR spectrum) of the obtained solution at 135° C. using a proton nuclear magnetic resonance apparatus (trade name of AVANCE 600) manufactured by Bruker, and

(iv) obtaining the content of a propylene unit based on an integrated value of a signal observed between 0.7 and 1.1 ppm of the above-mentioned spectrum, and the content of a trichlorosilylnorbornene unit based on an integrated value of a signal observed between 0.4 and 0.5 ppm of said spectrum, respectively; and the Q value was measured according to a gel permeation chromatography (GPC), using a solution of about 5 mg of the copolymer rubber dissolved in 5 ml of o-dichlorobenzene, under the following conditions:

(i) an apparatus, a trade name of 150C/GPC, manufactured by Waters Co., was used as a GPC apparatus,

(ii) a column, a trade name of SHODEX PACKED COLUMN A-80M, manufactured by Showa Denko K.K., was used as a column,

(iii) 400 micro-litters of the above-mentioned solution was injected,

(iv) an elution temperature was adjusted to 140° C.,

(v) a flow rate of the solution eluted was controlled to 1.0 ml/min,

(vi) a refractivity detector was used as a detector, (vii) polystyrenes having molecular weights between 500-8,400,000, manufactured by Tosoh Corporation were used as a molecular weight standard reference material, and

(viii) a weight average molecular weight (Mw) and a number average molecular weight (Mn) were obtained as values converted to respective average molecular weights of the above-mentioned polystyrenes, and then, the molecular weight distribution, Mw/Mn (Q value), was obtained.

(3) Component (C)

\mathring{1} Component (C1)

Finely powdery silicic acid (trade name of NIPSIL VN3) manufactured by NIPPON SILICA Co., Ltd.

\mathring{2} Component (C2)

Carbon black (trade name of ASAHI 60G) manufactured by ASAHI CARBON Co., Ltd.

### 2. Evaluation of Durability

Durability was evaluated by a method comprising the steps of:

(i) making a No. 3 dumbbell shaped specimen according to JIS K 6251,

(ii) stretching the specimen repeatedly at 23° C. under a load of from 0.1 to 1.9 Kg at a frequency of 300 cpm with a steady load fatigue tester (trade name of NRF-08S) manufactured by Yoshimizu Co., Ltd., and

(iii) measuring the total stretching times (durability) when the specimen has been broken.

### Reference Example 1

To a 2 liter-glass polymerization reactor equipped with a stirrer and a condenser, there were introduced 1 liter of hexane as a polymerization solvent and 5 mmol of 5-trichlorosilyl-2-norborene.

Each of ethylene gas, propylene gas and hydrogen gas (molecular weight controller) was introduced into the above-mentioned hexane at a feeding rate of 4 NL/minute, 6 NL/minute and 1 NL/minute, respectively, from an upper part of the polymerization reactor, and inner temperature of the polymerization reactor was maintained at 30° C. with a water bath.

Then, 1.6 mmol of ethyl aluminum sesquichloride and 0.2 mmo of vanadium oxytrichloride were added to the polymerization reactor in this order, and polymerization was initiated.

After 30 minutes from the initiation, 10 ml of methanol containing 0.1 g of 2,6-di-t-butyl-p-cresol (trade name of SUMILIZER BHT, manufactured by Sumitomo Chemical Co., Ltd.) was added to the obtained polymerization reaction mixture to terminate the polymerization. The obtained copolymer rubber solution was concentrated, and the copolymer rubber was recovered by a methanol-precipitation method. The recovered copolymer rubber was vacuum-dried at 80° C. for 12 hours, thereby obtaining 4.92 g of an ethylene-propylene-trichlorosilylnorbornene copolymer rubber.

### Example 1

To 140 parts by weight of the above-mentioned component (A), namely, to 140 parts by weight of the oil-extended ethylene-propylene-5-ethylidene-2-norbornene copolymer rubber containing 40 parts by weight of the extender oil, there were added:

(1) 1.5 part by weight of the above-mentioned component (B1),

(2) 40 parts by weight of the above-mentioned component (C1),

(3) 10 parts by weight of the above-mentioned component (C2),

(4) 5 parts by weight of zinc oxide,

(5) 1 part by weight of stearic acid,

(6) 5 parts by weight of paraffin oil having a trade name of DIANA PW90 manufactured by Idemitsu Kosan Co., Ltd.,

(7) 2 parts by weight of polyethylene glycol, and

(8) 2 parts by weight of γ-mercaptopropyltrimethoxysilane having a weight average molecular weight of 196.4, which is a silane coupling agent (trade name of A-189) manufactured by Nippon Unicar Co., Ltd.; thereby obtaining a mixture thereof.

The mixture was kneaded for 5 minutes at a rotor revolution speed of 60 rpm with a 1,700 ml-volume Banbury mixer, whose starting temperature was regulated at 80° C., and thereby obtaining a kneaded product.

To the kneaded product, there were added:

(1) 3 parts by weight of α, α′-bis(tert-butylperoxy)diisopropylbenzene (trade name of PERBUTYL P), which is an organic peroxide manufactured by NOF Corporation, and

(2) 1.0 part by weight of ethylene glycol dimethacrylate (trade name of ACRYESTER ED), which is a crosslinking coagent manufactured by Mitsubishi Rayon Co., Ltd.; and the obtained mixture was kneaded with an 8-inch open roll, thereby obtaining a rubber composition. The rubber composition was pressed at 170° C. for 20 minutes to obtain vulcanized rubber, durability of which was evaluated. Results are shown in Table 1.

### Comparative Example 1

Example 1 was repeated except that the component (B1) was not used. Results are shown in Table 1.

### Example 2

Example 1 was repeated except that the component (B1) was changed to the component (B2); 25 parts by weight of the component (C1) was added; 5 parts by weight of the component (C2) was added; and the silane coupling agent was not used. Results are shown in Table 1.

### Comparative Example 2

Example 2 was repeated except that the component (B2) was not used. Results are shown in Table 1.

TABLE 1

| | Example | | Comparative Example | |
|---|---|---|---|---|
| | 1 | 2 | 1 | 2 |
| Component (A) | 100 | 100 | 100 | 100 |
| Component (B) | | | | |
| Component (B1) | 1.5 | — | — | — |
| Component (B2) | — | 1.5 | — | — |
| Component (C) | | | | |
| Component (C1) | 40 | 25 | 40 | 25 |
| Component (C2) | 10 | 5 | 10 | 5 |
| ZnO | 5 | 5 | 5 | 5 |
| Stearic acid | 1 | 1 | 1 | 1 |
| Paraffin oil | 5 | 5 | 5 | 5 |
| Polyethylene glycol | 2 | 2 | 2 | 2 |
| Silane coupling agent | 2 | — | 2 | — |
| Durability (times) | 20 × 10⁴ | 30 × 10⁴ | 11 × 10⁴ | 11 × 10⁴ |

1. A rubber composition comprising the following components (A), (B1) and (C):
(A) an ethylene-α-olefin copolymer rubber and/or an ethylene-α-olefin-non-conjugated diene copolymer rubber,
(B1) an organic compound having a weight average molecular weight of from 1,000 to 1,000,000, and containing a silicon atom in an amount of from 2 to 30% by weight, wherein the total amount of the organic compound is 100% by weight, and
(C) a reinforcement.

2. The rubber composition according to claim 1, wherein the weight average molecular weight of the component (B1) is from 100,000 to 800,000, and the amount of silicon atom contained in the component (B1) is from 3 to 28% by weight.

3. The rubber composition according to claim 1, wherein the component (B1) is contained in an amount of from 0.1 to 50 parts by weight per 100 parts by weight of the component (A) contained therein.

4. A vulcanized rubber produced by a process comprising the step of vulcanizing the rubber composition according to claim 1.

5. A rubber composition comprising the following components (A), (B2) and (C):
(A) an ethylene-α-olefin copolymer rubber and/or an ethylene-α-olefin-non-conjugated diene copolymer rubber,
(B2) an ethylene-α-olefin-silylnorbornene copolymer rubber, and
(C) a reinforcement.

6. The rubber composition according to claim 5, wherein the component (B2) contains a silicon atom in an amount of from 0.1 to 30% by weight, wherein the total amount of the component (B2) is 100% by weight.

7. The rubber composition according to claim 5, wherein the component (B2) is contained in an amount of from 0.1 to 50 parts by weight per 100 parts by weight of the component (A) contained therein.

8. A vulcanized rubber produced by a process comprising the step of vulcanizing the rubber composition according to claim 5.
